(19) United States
(12) Patent Application Publication
(10) Pub. No.: US 2006/0095453 A1
(43) Pub. Date: May 4, 2006

(54) Providing a user a non-degraded presentation experience while limiting access to the non-degraded presentation experience

(76) Inventors: Mark S. Miller, Baltimore, MD (US); Alan H. Karp, Palo Alto, CA (US); Mark Yoshikawa, Hayward, CA (US); Susie Wee, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,271

(22) Filed: Oct. 29, 2004

(51) Int. Cl. G06F 17/30

(52) U.S. Cl. 707/101

(57) ABSTRACT

A user is provided a non-degraded presentation experience from data while access to the non-degraded presentation experience is limited. In an embodiment, one or more attributes are gathered from one or more sources. The data is accessed. Further, the data is adapted using the one or more attributes so that availability of the non-degraded presentation to the user is dependent on the one or more attributes. Examples of attributes include user attributes, environmental attributes, and presentation attributes.

### BACKGROUND OF THE INVENTION

1. Field of the Invention

The present invention generally relates to methods and systems for providing a presentation experience to a user. More particularly, the present invention relates to providing a user a non-degraded presentation experience while limiting access to the non-degraded presentation experience.

2. Related Art

Substantial effort and costs have been invested in protecting every type of electronic data (e.g., software programs, movies, music, books, text, graphics, etc.) from unauthorized use. Typically, a protection scheme is developed and implemented in hardware and/or software. This prompts organized and unorganized attempts to defeat the protection scheme. Since a single successful attack on the protection scheme can result in completely undermining the protection scheme, the cost of implementing the protection scheme is significantly greater than the cost of defeating the protection scheme.

Moreover, once the protection scheme is defeated, the data can be easily copied and provided to unauthorized users, denying revenue streams to the creators of the data.

Even if an impenetrable protection scheme is crafted, the data may still be susceptible to unauthorized copying via the “analog hole”. Data that is self-revealing is particularly susceptible via the “analog hole”. Self-revealing data refers to data that delivers its value to the user only by revealing (or presenting) the information of which it is composed. That is, self-revealing data provides a visual and/or audio presentation experience to the user. Examples of self-revealing data include movies, music, books, text, and graphics. The “analog hole” is the presentation experience that reveals sound and/or images that can be easily recorded, copied, and distributed to unauthorized users.

In contrast, a software program is an example of non self-revealing data. For instance, the value of a chess software program lies in the chess algorithm of the chess software program. Even if a great number of chess games are played and recorded, there still are unplayed chess games that have to be played to discover additional elements of the chess algorithm of the chess software program.

Thus, the “analog hole” has to be “plugged” to ensure that any implemented protection scheme is not undermined by the “analog hole”.

### SUMMARY OF THE INVENTION

A user is provided a non-degraded presentation experience from data while access to the non-degraded presentation experience is limited. In an embodiment, one or more attributes are gathered from one or more sources. The data is accessed. Further, the data is adapted using the one or more attributes so that availability of the non-degraded presentation to the user is dependent on the one or more attributes. Examples of attributes include user attributes, environmental attributes, and presentation attributes.

### BRIEF DESCRIPTION OF THE DRAWINGS

The accompanying drawings, which are incorporated in and form a part of this specification, illustrate embodiments of the invention and, together with the description, serve to explain the principles of the present invention.

FIG. 1A illustrates a system in accordance with a first embodiment of the present invention

FIG. 1B illustrates a flow chart showing a method of providing a user a non-degraded presentation experience from data while limiting access to the non-degraded presentation experience in accordance with a first embodiment of the present invention.

FIG. 2A illustrates a system in accordance with a second embodiment of the present invention.

FIG. 2B illustrates a flow chart showing a method of providing a user a non-degraded presentation experience from data while limiting access to the non-degraded presentation experience in accordance with a second embodiment of the present invention.

FIG. 3 illustrates a system in accordance with a third embodiment of the present invention.

FIG. 4 illustrates a flow chart showing a method of providing a user a non-degraded presentation experience from data in an environment while limiting access to the non-degraded presentation experience in accordance with a third embodiment of the present invention.

FIG. 5 illustrates a system in accordance with a fourth embodiment of the present invention.

FIG. 6 illustrates a flow chart showing a method of providing a user a non-degraded presentation experience from data using a presentation device from a plurality of presentation devices while limiting access to the non-degraded presentation experience in accordance with a fourth embodiment of the present invention.

FIG. 7 illustrates a system in accordance with a fifth embodiment of the present invention.

FIG. 8 illustrates a flow chart showing a method of providing a user a non-degraded presentation experience from data using a presentation device from a plurality of presentation devices while limiting access to the non-degraded presentation experience in accordance with a fifth embodiment of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

As described above, the “analog hole” is the presentation experience that reveals sound and/or images that can be easily recorded, copied, and distributed to unauthorized users. In accordance with embodiments of the present invention, the “analog hole” is “plugged” by introducing customization into the presentation experience. The customization is achieved by adapting the data using nondeterministic information (e.g., user attribute from the user, environmental attribute, presentation attribute of a presentation device). This nondeterministic information can be static or dynamic. Presentation of the adapted data is intended to provide the user a non-degraded presentation experience and to cause unauthorized recordings of the adapted and presented data to make available solely a degraded presentation experience to unauthorized users.

Since the ideal non-degraded presentation experience can be subjective because different users have different expectations, it should be understood that “non-degraded presentation experience” refers to a range of presentation experiences. At one end of this range lies a truly non-degraded presentation experience. While at the other end of this range lies a minimally degraded presentation experience that is sufficiently acceptable to the user.

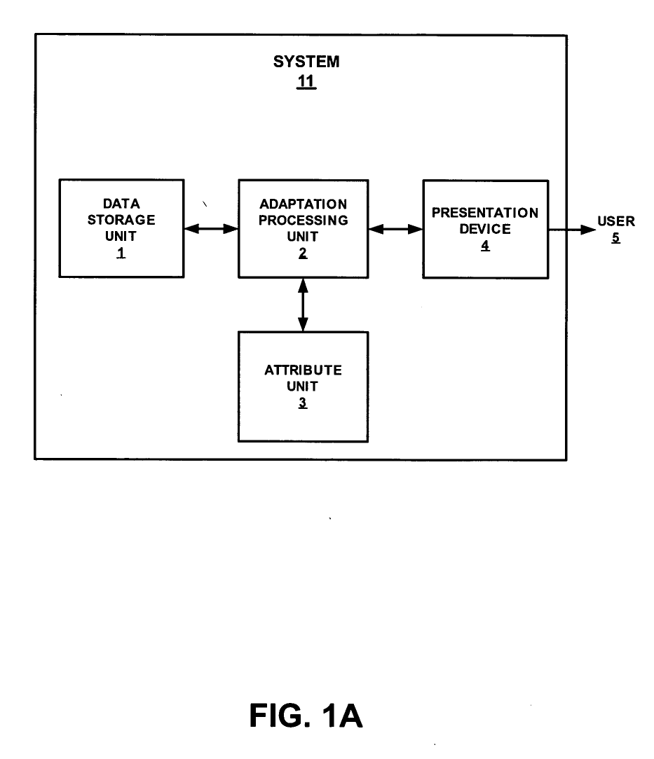

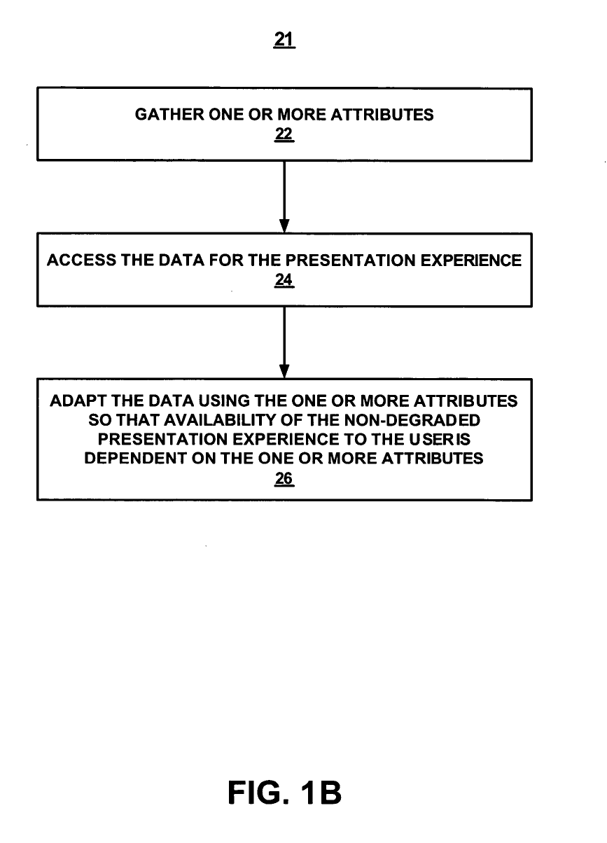

FIG. 1A illustrates a system 11 in accordance with a first embodiment of the present invention. As depicted in FIG. 1A, the system 11 includes a data storage unit 1, an adaptation processing unit 2, an attribute unit 3, and a presentation device 4. The system 1 provides the user 5 a non-degraded presentation experience from data stored in the data storage unit 1 while limiting access to the non-degraded presentation experience.

The data storage unit 1 can store any type of data (e.g., audio, visual, textual, self-revealing data, non self-revealing data, etc.). As described above, examples of self-revealing data include movies, music, books, text, and graphics. In an embodiment, the system 11 implements a protection scheme for the data.

The attribute unit 3 gathers one or more attributes. The attributes can be gathered from one or more sources. Examples of these sources include users, environments where the system 11 is located, and presentation devices. Moreover, the attributes can be static or dynamic. In the case of static attributes, the attribute unit 3 makes a one-time determination of these static attributes before the presentation experience is started. In the case of dynamic attributes, the attribute unit 3 initially determines values for these dynamic attributes and then proceeds to track changes over time in these dynamic attributes.

Continuing, the presentation device 4 presents the adapted data from the adaptation processing unit 2 to the user 5, providing the user 5 the presentation experience. Examples of the presentation device 4 include one or more television monitors, computer monitors, and/or speakers. The presentation device 4 can be designed for visual and/or acoustical presentation to the user 5. Moreover, the presentation device 4 can present the adapted data to multiple users instead of a single user.

Referring to FIG. 1A, the adaptation processing unit 2 receives one or more attributes from the attribute unit 3. Moreover, the adaptation processing unit 2 receives the data from the data storage unit 1. The adaptation processing unit 2 adapts the data using the one or more attributes from the attribute unit 3. This adaptation ensures that availability of a non-degraded presentation experience to the user 5 is dependent on the one or more attributes. The manner of adapting the data can occur according to several techniques. In one technique, adapting the data includes degrading the data using the attributes in a way that may minimally degrade the presentation experience but is still sufficiently acceptable by the user. For example, a first portion of the image on the presentation device 4 where the user's eyes are focused is presented in a high resolution (non-degraded state) while outside of this first portion the image is presented in a low resolution (degraded state). In another technique, adapting the data includes modifying the data using the attributes in a way that may minimally degrade the presentation experience but is still sufficiently acceptable by the user. For example, the data is slightly warped in some imperceptible way to make difficult any recording of the presentation experience. In yet another technique, adapting the data includes adding new data to the data using the attributes in a way that may minimally degrade the presentation experience but is still sufficiently acceptable by the user. For example, the first portion of the image on the presentation device 4 where the user's eyes are focused is presented in a high resolution while outside of this first portion visual noise, false/extraneous objects, etc. are added to the image. Similarly, at the hearing position of the user 5, the user 5 hears the presented audio data while outside of the hearing position of the user 5 other persons hear any added audio noise.

FIG. 1B illustrates a flow chart showing a method 21 of providing a user a non-degraded presentation experience from data while limiting access to the non-degraded presentation experience in accordance with a first embodiment of the present invention. Reference is also made to FIG. 1A.

At 22, one or more attributes are gathered by the attribute unit 3. Sources for the attributes include users, environments where the system 11 is located, and presentation devices. At 24, data for the presentation experience is accessed from the data storage unit 1.

Further, at 26, the data is adapted using the one or more attributes so that availability of the non-degraded presentation experience to the user 5 is dependent on the one or more attributes. In an embodiment, an adaptation processing unit 2 performs the adaptation. Moreover, the adapted data is presented using the presentation device 4, providing the non-degraded presentation experience, which is dependent on the attributes.

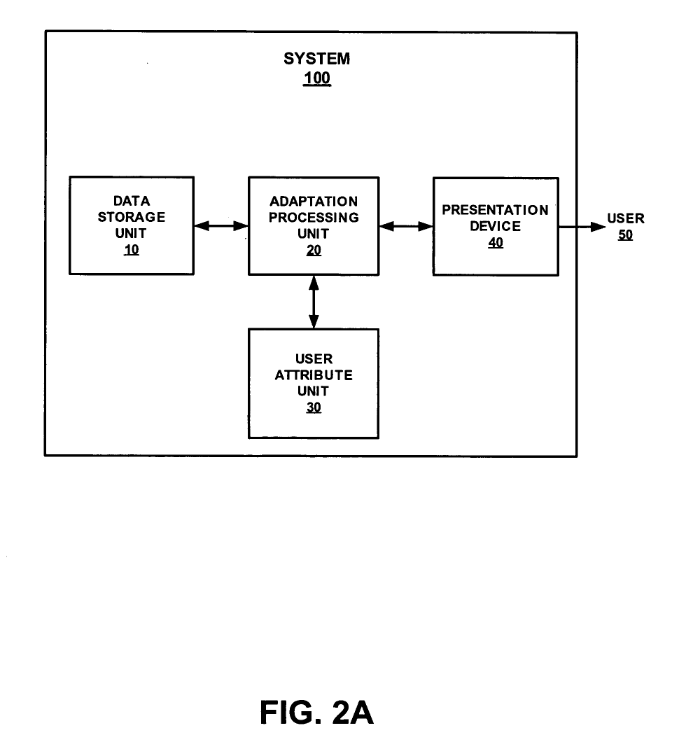

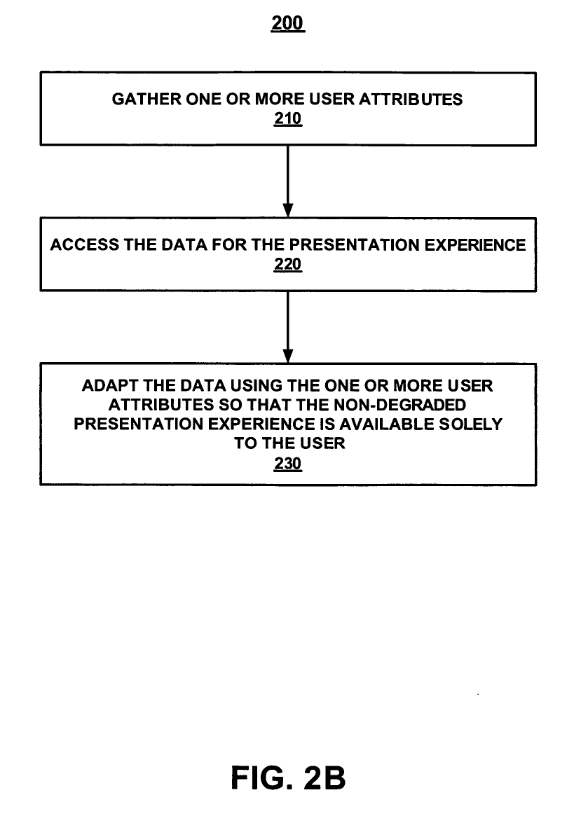

FIG. 2A illustrates a system 100 in accordance with a second embodiment of the present invention. As depicted in FIG. 2A, the system 100 includes a data storage unit 10, an adaptation processing unit 20, a user attribute unit 30, and a presentation device 40. The system 100 provides the user 50 a non-degraded presentation experience from data stored in the data storage unit 10 while limiting access to the non-degraded presentation experience.

The data storage unit 10 can store any type of data (e.g., audio, visual, textual, self-revealing data, non self-revealing data, etc.). As described above, examples of self-revealing data include movies, music, books, text, and graphics. In an embodiment, the system 100 implements a protection scheme for the data.

The user attribute unit 30 gathers one or more user attributes from the user 50. The user attributes can be static or dynamic. Examples of static user attributes are user's audio acuity and user's visual acuity. Examples of dynamic user attributes include eye movement, head movement, and virtual movement in a virtual environment. In the case of static attributes, the user attribute unit 30 makes a one-time determination of these static user attributes before the presentation experience is started. In the case of dynamic attributes, the user attribute unit 30 initially determines values for these dynamic user attributes and then proceeds to track changes over time in these dynamic user attributes. As will be explained below, tracked eye movement facilitates adapting data that will be visually presented to the user 50. Continuing, tracked head movement facilitates adapting data that will be acoustically presented to the user 50. Further, tracked virtual movement facilitates adapting data that will be visually presented to the user 50 in a virtual environment. Moreover, the user attribute unit 30 can track one or more attributes of multiple users.

For tracking eye movement, the user attribute unit 30 may utilize one or more eye tracking techniques. Examples of eye tracking techniques include reflected light tracking techniques, electro-aculography tracking techniques, and contact lens tracking techniques. Although these exemplary eye tracking techniques are well-suited for the user attribute unit 30, it should be understood that other eye tracking techniques are also well-suited for the user attribute unit 30. Since the accuracy of each eye tracking technique is less than ideal, use of multiple eye tracking techniques increases accuracy. On the other hand, the user attribute unit 30 may utilize one or more position tracking techniques to track head movement of the user 50. Furthermore, the user attribute unit 30 may utilize one or more virtual movement tracking techniques to track virtual movement of the user 50. Examples of virtual movement tracking techniques include suit-based tracking techniques, mouse-based tracking techniques, and movement controller-based tracking techniques.

The presentation device 40 presents the adapted data from the adaptation processing unit 20 to the user 50, providing the user 50 the presentation experience. Examples of the presentation device 40 include one or more television monitors, computer monitors, and/or speakers. The presentation device 40 can be designed for visual and/or acoustical presentation to the user 50.

Referring to FIG. 2A, the adaptation processing unit 20 receives one or more user attributes (e.g., eye movement, head movement, and virtual movement in a virtual environment, user's visual acuity, user's audio acuity, etc.) gathered by the user attribute unit 30. Moreover, the adaptation processing unit 20 receives the data from the data storage unit 10. The adaptation processing unit 20 adapts the data using the one or more user attributes from the user 50 gathered by the user attribute unit 30. In the case of dynamic user attributes, this adaptation is dynamic. Moreover, adaptation of the data using static or dynamic user attributes ensures that a non-degraded presentation experience produced by the presentation device 40 is available solely to the user 50. The manner of adapting the data can occur according to several techniques, as described above. These techniques include degrading, modifying, and/or adding new data to the data using the attributes in a way that may minimally degrade the presentation experience but is still sufficiently acceptable by the user 50.

In the case of data that will be visually presented to the user 50, the adaptation processing unit 20 may utilize static user attributes (e.g., user's 50 visual acuity) and/or dynamic user attributes (e.g., eye movement). Focusing on tracked eye movement of the user 50, instead of processing the data for visually presenting the entire data in a high-resolution state (or non-degraded state), the adaptation processing unit 20 adapts the data such that the data that will be visually presented in the foveal field of the user's 50 visual field is maintained in a high-resolution state for the reasons that will be described below. The tracked eye movement determines the origin location of the foveal field and the destination location of the foveal field. While the eye movement is causing the foveal field to move from an origin location to a destination location, it is possible to visually present the data in a state other than a high resolution state since the user's 50 visual system is greatly suppressed (though not entirely shut off) during this type of eye movement. Further, the adaptation processing unit 20 adapts the data that will be visually presented outside the foveal field of the user's 50 visual field to a low-resolution state (or degraded state). Thus, the user 50 is provided a non-degraded presentation experience while an unauthorized recording of the output of the presentation device 40 captures mostly low-resolution data with a minor high-resolution zone that moves unpredictably. This unauthorized recording simply provides a degraded presentation experience to an unauthorized user. It is unlikely that the user 50 and the unauthorized user would have the same sequence of eye movements since there are involuntary and voluntary eye movements. Additionally, the user 50 gains a level of privacy since another person looking at the output of the presentation device 40 would mostly see low-resolution data with a minor high-resolution zone that moves unpredictably. Thus, the user 50 is able to use the system 100 in a public place and is still able to retain privacy.

In general, the user's 50 visual field is comprised of the foveal field and the peripheral field. The retina of the eye has an area known as the fovea that is responsible for the user's sharpest vision. The fovea is densely packed with “cone”-type photoreceptors. The fovea enables reading, watching television, driving, and other activities that require the ability to see detail. Thus, the eye moves to make objects appear directly on the fovea when the user 50 engages in activities such as reading, watching television, and driving. The fovea covers approximately 1 to 2 degrees of the field of view of the user 50. This is the foveal field. Outside the foveal field is the peripheral field. Typically, the peripheral field provides 15 to 50 percent of the sharpness and acuity of the foveal field. This is generally inadequate to see an object clearly. It follows, conveniently for eye tracking purposes, that in order to see an object clearly, the user must move the eyeball to make that object appear directly on the fovea. Hence, the user's 50 eye position as tracked by the user attribute unit 30 gives a positive indication of what the user 50 is viewing clearly at the moment.

Contrary to the user's 50 perception, the eye is rarely stationary. It moves frequently as it sees different portions of the visual field. There are many different types of eye movements. Some eye movements are involuntary, such as rolling, nystagmus, drift, and microsaccades. However, saccades can be induced voluntarily. The eye does not generally move smoothly over the visual field. Instead, the eye makes a series of sudden jumps, called saccades, and other specialized movements (e.g., rolling, nystagmus, drift, and microsaccades). The saccade is used to orient the eyeball to cause the desired portion of the visual field fall upon the fovea. It is sudden, rapid movement with high acceleration and deceleration rates. Moreover, the saccade is ballistic, that is, once a saccade begins, it is not possible to change its destination or path. The user's 50 visual system is greatly suppressed (though not entirely shut off) during the saccade. Since the saccade is ballistic, its destination must be selected before movement begins. Since the destination typically lies outside the foveal field, the destination is selected by the lower acuity peripheral field.

Continuing, in the case of data that will be acoustically presented to the user 50, the adaptation processing unit 20 may utilize static user attributes (e.g., user's 50 audio acuity) and/or dynamic user attributes (e.g., head movement). Focusing on tracked head movement of the user 50, instead of processing the data for acoustically presenting the entire data in a non-degraded state, the adaptation processing unit 20 adapts the data such that the data that will be acoustically presented and heard at the hearing position of the user 50 is in a non-degraded state. The tracked head movement determines the hearing position of the user 50. However, the adaptation processing unit 20 adapts the data that will be acoustically presented and heard outside of the hearing position of the user 50 into a degraded state. Thus, the user 50 is provided a non-degraded presentation experience while an unauthorized recording of the output of the presentation device 40 captures mostly degraded sound. This unauthorized recording simply provides a degraded presentation experience to an unauthorized user. It is unlikely that the user 50 and the unauthorized user would have the same sequence of head movements.

In an embodiment, data that will be acoustically presented to the user 50 is a binaural recording. A binaural recording is a two-channel (e.g., right channel and left channel) recording that attempts to recreate the conditions of human hearing, reproducing the full three-dimensional sound field. Moreover, frequency, amplitude, and phase information contained in each channel enable the auditory system to localize sound sources. In the non-degraded presentation experience, the user 50 (at the hearing position indicated by tracking head movement of the user 50) perceives sound as originating from a stable source in the full three-dimensional sound field. However, in the degraded presentation experience, the unauthorized user perceives sound as originating from a wandering source in the full three-dimensional sound field, which can be quite distracting.

Further, in the case of data that will be visually presented to the user 50 in a virtual environment, the adaptation processing unit 20 may utilize a dynamic user attribute such as virtual movement of the user 50, wherein the virtual movement is tracked. Instead of processing the data for visually presenting in the virtual environment the entire data in a non-degraded state, the adaptation processing unit 20 adapts the data such that the data that will be visually presented in the virtual environment at the position of the user 50 in the virtual environment is in a non-degraded state. The tracked virtual movement determines the position of the user 50 in the virtual environment. However, the adaptation processing unit 20 adapts the data that will be visually presented in the virtual environment outside the position of the user 50 in the virtual environment into a degraded state. Thus, the user 50 is provided a non-degraded presentation experience while an unauthorized recording of the output of the presentation device 40 does not capture sufficient data to render the virtual environment for a path other than that followed by the user 50. This unauthorized recording simply provides a degraded presentation experience to an unauthorized user since it is unlikely that the user 50 and the unauthorized user would proceed along the same paths in the virtual environment.

FIG. 2B illustrates a flow chart showing a method 200 of providing a user a non-degraded presentation experience from data while limiting access to the non-degraded presentation experience in accordance with a second embodiment of the present invention. Reference is also made to FIG. 2A.

At 210, one or more user attributes from the user 50 are gathered by the user attribute unit 30. Examples of user attributes include user's visual acuity, user's audio acuity, eye movement, head movement, and virtual movement in a virtual environment. At 220, the data for the presentation experience is accessed from the data storage unit 10.

Continuing, at 230, the data is adapted using the one or more user attributes so that the non-degraded presentation experience is available solely to the user 50. In an embodiment, an adaptation processing unit 20 performs the adaptation. Moreover, the adapted data is presented to the user 50 using the presentation device 40, providing the non-degraded presentation experience to the user.

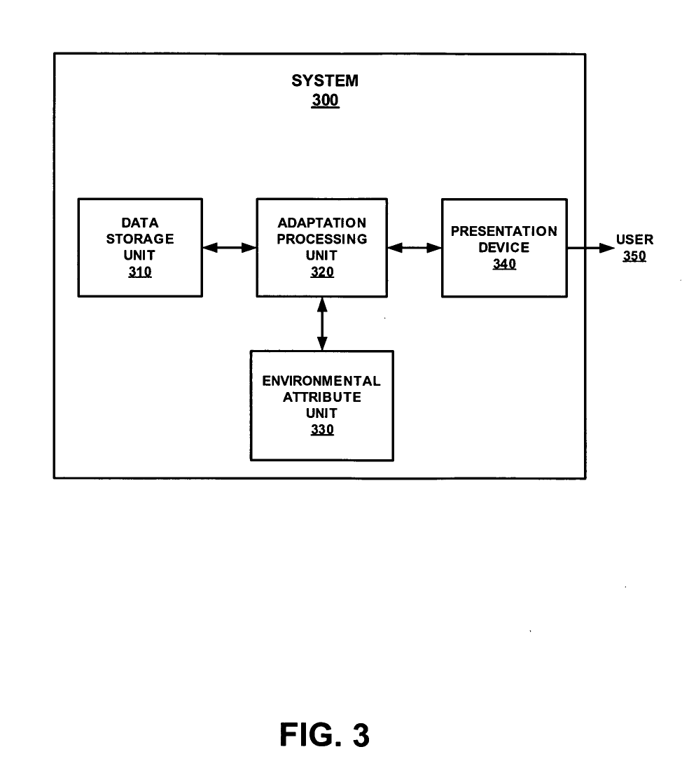

FIG. 3 illustrates a system 300 in accordance with a third embodiment of the present invention. As depicted in FIG. 3, the system 300 includes a data storage unit 310, an adaptation processing unit 320, an environmental attribute unit 330, and a presentation device 340. The system 300 provides the user 350 a non-degraded presentation experience from data stored in the data storage unit 310 in an environment (e.g., a room) in which the system 300 is located while limiting access to the non-degraded presentation experience.

The data storage unit 310 can store any type of data (e.g., audio, visual, textual, self-revealing data, non self-revealing data, etc.). As described above, examples of self-revealing data include movies, music, books, text, and graphics. In an embodiment, the system 300 implements a protection scheme for the data.

The environmental attribute unit 330 gathers one or more environmental attributes of the environment in which the system 300 is located. Examples of environmental attributes include acoustical attributes and optical attributes. The acoustical attributes facilitate adapting data that will be acoustically presented to the user 350. Dimensions of a room; rigidity and mass of the walls, ceiling, and floor of the room; sound reflectivity of the room; and ambient sound are examples of acoustical attributes. Continuing, optical attributes facilitate adapting data that will be visually presented to the user 350. Dimensions of the room, optical reflectivity of the room, color balance of the room, and ambient light are examples of optical attributes.

The acoustical/optical environmental attributes can be static or dynamic. In the case of static environmental attributes, the environmental attribute unit 330 makes a one-time determination of these static environmental attributes before the presentation experience is started. In the case of dynamic environmental attributes, the environmental attribute unit 330 initially determines values for these dynamic environmental attributes and then proceeds to track changes over time in these dynamic environmental attributes.

The presentation device 340 presents the adapted data from the adaptation processing unit 320 to the user 350, providing the user 350 the presentation experience. Examples of the presentation device 340 include one or more television monitors, computer monitors, and/or speakers. The presentation device 340 can be designed for visual and/or acoustical presentation to the user 350.

Continuing with FIG. 3, the adaptation processing unit 320 receives one or more environmental attributes (e.g., acoustical attributes and optical attributes) of the environment in which the system 300 is located and determined by the environmental attribute unit 330. Moreover, the adaptation processing unit 320 receives the data from the data storage unit 310. The adaptation processing unit 320 adapts the data using the one or more environmental attributes of the environment in which the system 300 is located and gathered by the environmental attribute unit 330. This adaptation ensures that a non-degraded presentation experience produced by the presentation device 340 is available solely in the environment in which the system 300 is located. The manner of adapting the data can occur according to several techniques, as described above. These techniques include degrading, modifying, and/or adding new data to the data using the attributes in a way that may minimally degrade the presentation experience but is still sufficiently acceptable by the user 350.

Thus, the user 350 is provided a non-degraded presentation experience in the environment in which the system 300 is located. An unauthorized recording of the output of the presentation device 340 may capture the non-degraded presentation experience. However, this unauthorized recording simply provides a degraded presentation experience to an unauthorized user outside the environment in which the system 300 is located. This is the case since it is unlikely that the environment in which the system 300 is located and the environment in which the unauthorized user is located would have the same environmental attributes.

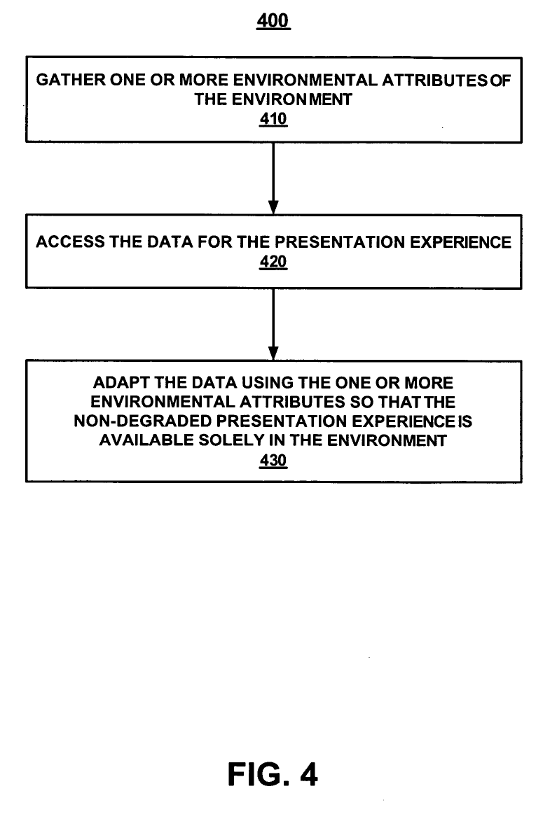

FIG. 4 illustrates a flow chart showing a method 400 of providing a user a non-degraded presentation experience from data in an environment while limiting access to the non-degraded presentation experience in accordance with a third embodiment of the present invention. Reference is also made to FIG. 3.

At 410, one or more environmental attributes of the environment in which the system 300 is located are gathered by the environmental attribute unit 330. Examples of the environmental attributes include acoustical attributes and optical attributes. At 420, the data for the presentation experience is accessed from the data storage unit 310.

Continuing, at 430, the data is adapted using the one or more environmental attributes so that the non-degraded presentation experience is available solely in the environment in which the system 300 is located. In an embodiment, an adaptation processing unit 320 performs the adaptation. Moreover, the adapted data is presented to the user 350 using the presentation device 340, providing the non-degraded presentation experience to the user.

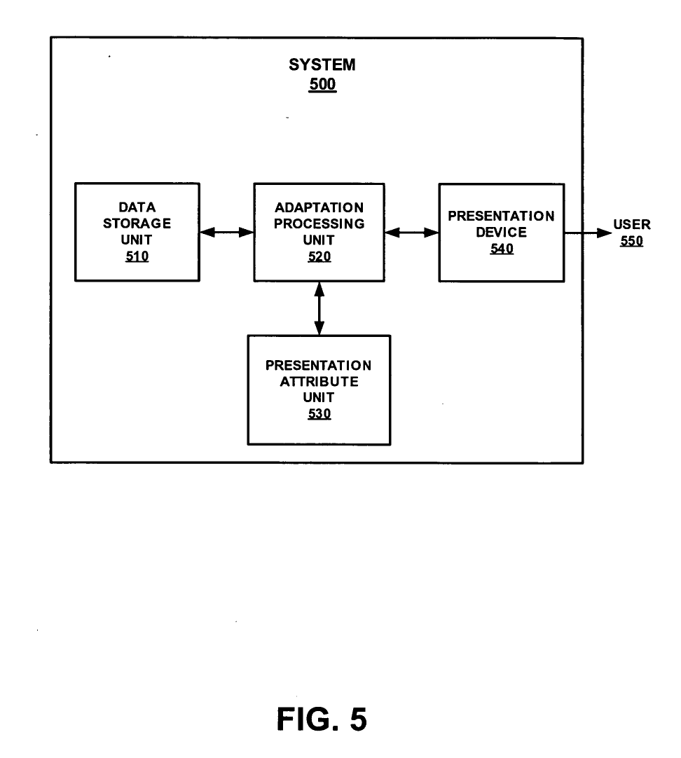

FIG. 5 illustrates a system 500 in accordance with a fourth embodiment of the present invention. As depicted in FIG. 5, the system 500 includes a data storage unit 510, an adaptation processing unit 520, a presentation attribute unit 530, and a presentation device 540. The system 500 provides the user 550 a non-degraded presentation experience from data stored in the data storage unit 510 using the presentation device 540 from a plurality of presentation devices while limiting access to the non-degraded presentation experience.

The data storage unit 510 can store any type of data (e.g., audio, visual, textual, self-revealing data, non self-revealing data, etc.). As described above, examples of self-revealing data include movies, music, books, text, and graphics. In an embodiment, the system 500 implements a protection scheme for the data.

The presentation attribute unit 530 gathers one or more presentation attributes of the presentation device 540. Each one of the plurality of presentation devices has distinct presentation attributes. Examples of presentation attributes include acoustical presentation attributes and visual presentation attributes. The acoustical presentation attributes facilitate adapting data that will be acoustically presented to the user 550. Fidelity range, sound distortion profile, and sound frequency response are examples of acoustical presentation attributes. Moreover, the hearing attributes of the user 550 can be determined and used in adapting data that will be acoustically presented to the user 550. Continuing, visual presentation attributes facilitate adapting data that will be visually presented to the user 550. Pixel resolution, aspect ratio, pixel shape, and pixel offsets are examples of visual presentation attributes. In an embodiment, data that will be visually presented to the user 550 has sufficient information to support higher pixel resolutions than supported by any one of the plurality of presentation devices including presentation device 540.

The acoustical/visual presentation attributes can be static or dynamic. In the case of static presentation attributes, the presentation attribute unit 530 makes a one-time determination of these static presentation attributes before the presentation experience is started. In the case of dynamic presentation attributes, the presentation attribute unit 530 initially determines values for these dynamic presentation attributes and then proceeds to track changes over time in these dynamic presentation attributes.

The presentation device 540 presents the adapted data from the adaptation processing unit 520 to the user 550, providing the user 550 the presentation experience. Examples of the presentation device 540 include one or more television monitors, computer monitors, and/or speakers. The presentation device 540 can be designed for visual and/or acoustical presentation to the user 550. Instead of manufacturing a plurality of presentation devices with the same presentation attributes, each presentation device is manufactured to have a unique set of presentation attributes. The presentation device 540 is one of the plurality of presentation devices.

Continuing with FIG. 5, the adaptation processing unit 520 receives one or more presentation attributes (e.g., acoustical presentation attributes and visual presentation attributes) of the presentation device 540 determined by the presentation attribute unit 530. Moreover, the adaptation processing unit 520 receives the data from the data storage unit 510. The adaptation processing unit 520 adapts the data using the one or more presentation attributes of the presentation device 540 gathered by the presentation attribute unit 530. Additionally, the adaptation processing unit 520 can adapt the data using the hearing attributes of the user 550 in the case of data that will be acoustically presented to the user 550. This adaptation ensures that a non-degraded presentation experience produced by the presentation device 540 is available solely from the presentation device 540. The manner of adapting the data can occur according to several techniques, as described above. These techniques include degrading, modifying, and/or adding new data to the data using the attributes in a way that may minimally degrade the presentation experience but is still sufficiently acceptable by the user 550.

Thus, the user 550 is provided a non-degraded presentation experience from the presentation device 540. An unauthorized recording of the output of the presentation device 540 may capture the non-degraded presentation experience. However, this unauthorized recording simply provides a degraded presentation experience to an unauthorized user using another presentation device to present the unauthorized recording. This is the case since the presentation device 540 and the presentation device used by the unauthorized user would have different presentation attributes.

For example, data that will be visually presented is resampled from a high pixel resolution to the lower pixel resolution supported by the presentation device 540. Since the unauthorized user will use a different presentation device, the unauthorized recording has to be resampled again from the lower pixel resolution supported by the presentation device 540 to either a higher pixel resolution than that of the presentation device 540 or a lower pixel resolution than that of the presentation device 540. This second resampling results in perceptible degradation in the quality of the visual presentation.

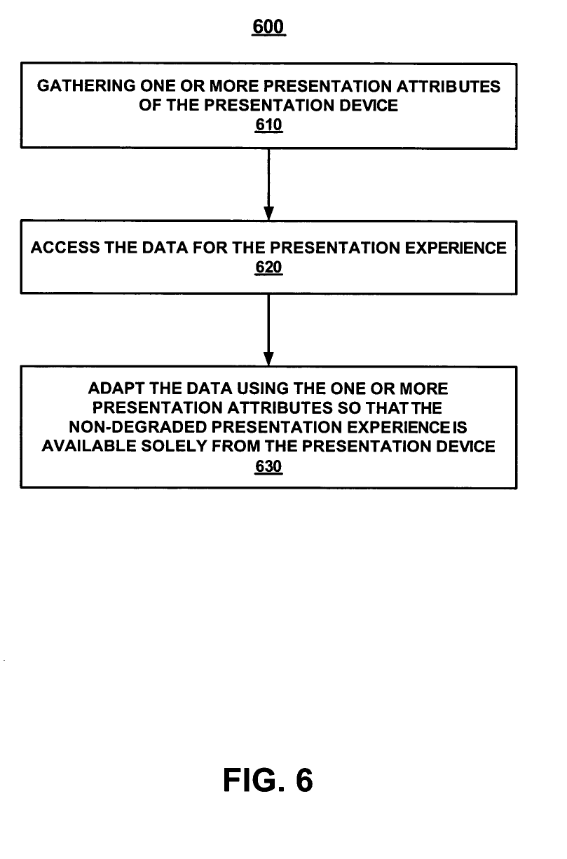

FIG. 6 illustrates a flow chart showing a method 600 of providing a user a non-degraded presentation experience from data using a presentation device from a plurality of presentation devices while limiting access to the non-degraded presentation experience in accordance with a fourth embodiment of the present invention. Reference is also made to FIG. 5.

At 610, one or more presentation attributes of the presentation device 540 are gathered by the presentation attribute unit 530. Examples of the presentation attributes include acoustical presentation attributes and visual presentation attributes. At 620, the data for the presentation experience is accessed from the data storage unit 510.

Continuing, at 630, the data is adapted using the presentation attributes so that the non-degraded presentation experience is available solely from the presentation device 540. In an embodiment, an adaptation processing unit 520 performs the adaptation. Moreover, the adapted data is presented to the user 550 using the presentation device 540, providing the non-degraded presentation experience to the user.

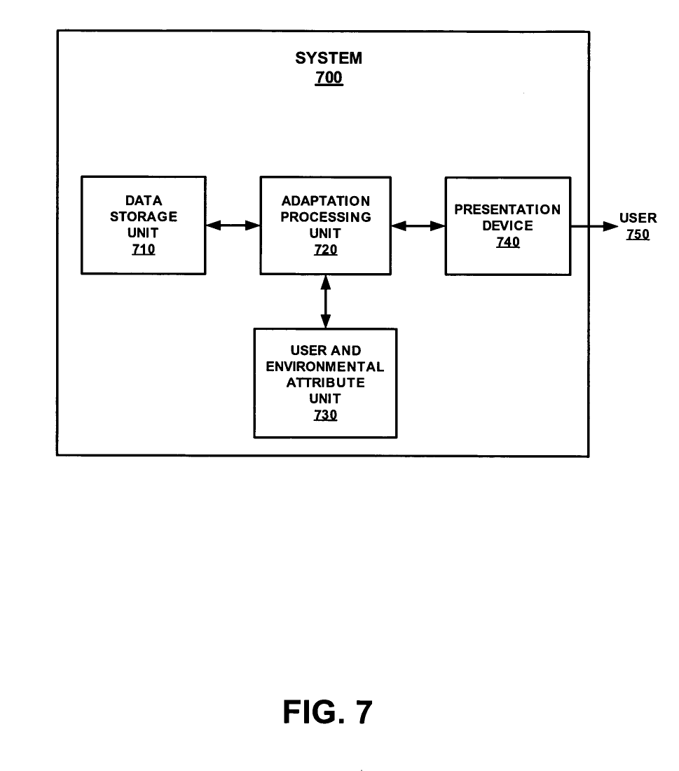

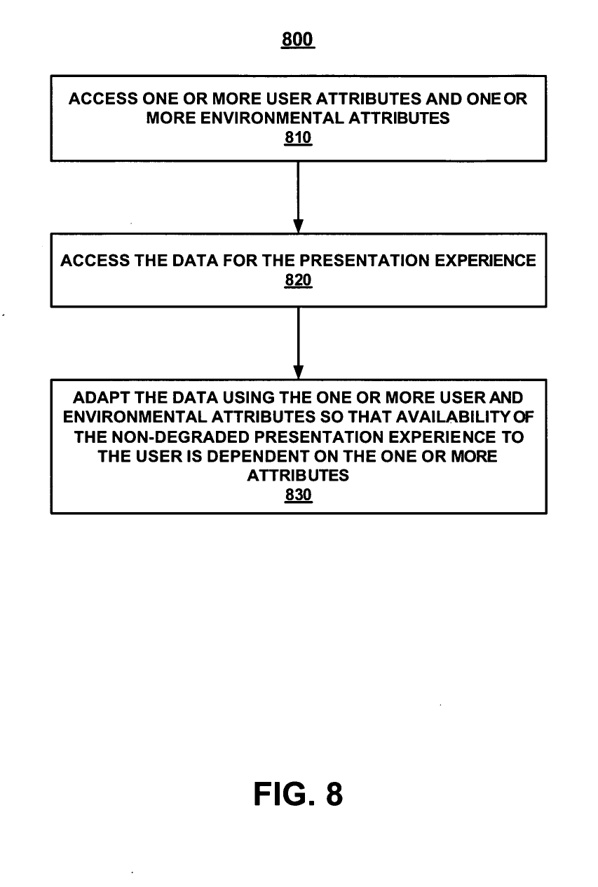

The embodiments of FIGS. 2A, 2B and 3-6 are separately described in order to more clearly describe certain aspects of the present invention; however, it is appreciated that the present invention may be implemented by combining elements of these embodiments. One such combination is discussed in conjunction with FIGS. 7 and 8, below.

FIG. 7 illustrates a system 700 in accordance with a fifth embodiment of the present invention. As depicted in FIG. 7, the system 700 includes a data storage unit 710, an adaptation processing unit 720, a user and environmental attribute unit 730, and a presentation device 740. The system 700 provides the user 750 a non-degraded presentation experience from data stored in the data storage unit 710 while limiting access to the non-degraded presentation experience.

The data storage unit 710 can store any type of data (e.g., audio, visual, textual, self-revealing data, non self-revealing data, etc.). The user and environmental attribute unit 730 provides one or more user attributes associated with the user 750 to the adaptation processing unit 720. The user and environmental attribute unit 730 also provides one or more environmental attributes associated with the environment of user 750 to the adaptation processing unit 720. The user and environmental attributes can be static or dynamic. Examples of user attributes and environmental attributes have been discussed above.

The presentation device 740 presents the adapted data from the adaptation processing unit 720 to the user 750, providing the user 750 the presentation experience. Examples of the presentation device 740 include one or more television monitors, computer monitors, and/or speakers.

FIG. 8 illustrates a flow chart showing a method 800 of providing a user a non-degraded presentation experience from data while limiting access to the non-degraded presentation experience in accordance with a fifth embodiment of the present invention. Reference is also made to FIG. 7.

At 810, one or more user attributes associated with the user 750 are accessed. Also, one or more environmental attributes associated with the environment of the user 750 are accessed. At 820, the data for the presentation experience is accessed from the data storage unit 710.

Continuing, at 830, in one embodiment, adaptation processing unit 720 adapts the data using the one or more user attributes and the one or more environmental attributes so that the non-degraded presentation experience is available solely to the user 750. The adapted data can then presented to the user 750 using the presentation device 740, providing the non-degraded presentation experience to the user.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method of providing a user a non-degraded presentation experience from data while limiting access to said non-degraded presentation experience, said method comprising:
gathering one or more attributes from one or more sources;
accessing said data; and
adapting said data using said one or more attributes so that said non-degraded presentation is available solely to said user and is dependent on said one or more attributes.

2. The method as recited in claim 1 wherein each attribute is one of a static attribute and a dynamic attribute.

3. The method as recited in claim 1 wherein said sources include said user, an environment, and a presentation device.

4. The method as recited in claim 1 wherein said adapting said data includes one of degrading said data, modifying said data, and adding new data to said data.

5. A system for providing a user a non-degraded presentation experience from data while limiting access to said non-degraded presentation experience, comprising:
a data storage unit for storing said data;
an attribute unit for gathering one or more attributes from one or more sources; and
an adaptation processing unit for adapting said data using said one or more attributes so that said non-degraded presentation is available solely to said user and is dependent on said one or more attributes.

6. The system as recited in claim 5 wherein each attribute is one of a static attribute and a dynamic attribute, and further comprising a presentation device for presenting said adapted data.

7. The system as recited in claim 5 wherein said sources include said user, an environment, and a presentation device.

8. The system as recited in claim 5 wherein said adaptation processing unit performs at least one of degrading said data, modifying said data, and adding new data to said data.

9. A method of providing a user a non-degraded presentation experience from data while limiting access to said non-degraded presentation experience, said method comprising:
gathering one or more user attributes from said user;
accessing said data; and
adapting said data using said one or more user attributes so that said non-degraded presentation experience is available solely to said user when said adapted data is presented to said user.

10. The method as recited in claim 9 wherein said gathering said one or more user attributes comprises tracking said one or more user attributes, and wherein a user attribute is eye movement.

11. The method as recited in claim 10 wherein said adapting said data includes:
in a foveal field of a visual field of said user as indicated by said eye movement, maintaining said data in a state supporting said non-degraded presentation experience; and
outside of said foveal field, maintaining said data in a state supporting a degraded presentation experience.

12. The method as recited in claim 9 wherein said gathering said one or more user attributes comprises tracking said one or more user attributes, and wherein a user attribute is head movement.

13. The method as recited in claim 12 wherein said adapting said data includes:
in a hearing position of said user as indicated by said head movement, maintaining said data in a state supporting said non-degraded presentation experience; and
outside of said hearing position, maintaining said data in a state supporting a degraded presentation experience.

14. The method as recited in claim 9 wherein said gathering said one or more user attributes comprises tracking said one or more user attributes, and wherein a user attribute is virtual movement in a virtual environment.

15. The method as recited in claim 14 wherein said adapting said data includes:
in a position of said user as indicated by said virtual movement, maintaining said data in a state supporting said non-degraded presentation experience; and
outside of said position, maintaining said data in a state supporting a degraded presentation experience.

16. The method as recited in claim 9 wherein each user attribute is one of a static user attribute and a dynamic user attribute.

17. A system for providing a user a non-degraded presentation experience from data while limiting access to said non-degraded presentation experience, comprising:
a data storage unit for storing said data;
a user attribute unit for gathering one or more user attributes from said user; and
an adaptation processing unit for adapting said data using said one or more user attributes so that said non-degraded presentation experience is available solely to said user.

18. The system as recited in claim 17 wherein said user attribute unit tracks a user attribute, wherein said user attribute is eye movement, and further comprising a presentation device for presenting said adapted data to said user.

19. The system as recited in claim 18 wherein said adaptation processing unit, in a foveal field of a visual field of said user as indicated by said eye movement, maintains said data in a state supporting said non-degraded presentation experience, and wherein said adaptation processing unit, outside of said foveal field, maintains said data in a state supporting a degraded presentation experience.

20. The system as recited in claim 17 wherein said user attribute unit tracks a user attribute, wherein said user attribute is head movement, and further comprising a presentation device for presenting said adapted data to said user.

21. The system as recited in claim 20 wherein said adaptation processing unit, in a hearing position of said user as indicated by said head movement, maintains said data in a state supporting said non-degraded presentation experience, and wherein said adaptation processing unit, outside of said hearing position, maintains said data in a state supporting a degraded presentation experience.

22. The system as recited in claim 17 wherein said user attribute unit tracks a user attribute, wherein said user attribute is virtual movement in a virtual environment, and further comprising a presentation device for presenting said adapted data to said user.

23. The system as recited in claim 22 wherein said adaptation processing unit, in a position of said user as indicated by said virtual movement, maintains said data in a state supporting said non-degraded presentation experience, and wherein said adaptation processing unit, outside of said position, maintains said data in a state supporting a degraded presentation experience.

24. The system as recited in claim 17 wherein each user attribute is one of a static user attribute and a dynamic user attribute.

25. A method of providing a user a non-degraded presentation experience from data in an environment while limiting access to said non-degraded presentation experience, said method comprising:
gathering one or more environmental attributes of said environment;
accessing said data; and
adapting said data using said one or more environmental attributes so that said non-degraded presentation experience is available solely in said environment when said adapted data is presented to said user.

26. The method as recited in claim 25 wherein said one or more environmental attributes are acoustical attributes of said environment.

27. The method as recited in claim 26 wherein said adapting said data includes adjusting said data to said acoustical attributes to provide said non-degraded presentation experience.

28. The method as recited in claim 25 wherein said one or more environmental attributes are optical attributes of said environment.

29. The method as recited in claim 28 wherein said adapting said data includes adjusting said data to said optical attributes to provide said non-degraded presentation experience.

30. The method as recited in claim 25 wherein each environmental attribute is one of a static environmental attribute and a dynamic environmental attribute.

31. A system for providing a user a non-degraded presentation experience from data in an environment while limiting access to said non-degraded presentation experience, comprising:
a data storage unit for storing said data;
an environmental attribute unit for gathering one or more environmental attributes of said environment; and
an adaptation processing unit for adapting said data using said one or more environmental attributes so that said non-degraded presentation experience is available solely in said environment.

32. The system as recited in claim 31 wherein said one or more environmental attributes are acoustical attributes of said environment, and further comprising a presentation device for presenting said adapted data to said user.

33. The system as recited in claim 32 wherein said adaptation processing unit adjusts said data to said acoustical attributes to provide said non-degraded presentation experience.

34. The system as recited in claim 31 wherein said one or more environmental attributes are optical attributes of said environment, and further comprising a presentation device for presenting said adapted data to said user.

35. The system as recited in claim 34 wherein said adaptation processing unit adjusts said data to said optical attributes to provide said non-degraded presentation experience.

36. The system as recited in claim 31 wherein each environmental attribute is one of a static environmental attribute and a dynamic environmental attribute.

37. A method of providing a user a non-degraded presentation experience from data using a presentation device from a plurality of presentation devices while limiting access to said non-degraded presentation experience, said method comprising:
gathering one or more presentation attributes of said presentation device, wherein each one of said presentation devices has distinct presentation attributes;
accessing said data; and
adapting said data using said one or more presentation attributes so that said non-degraded presentation experience is available solely from said presentation device when said adapted data is presented to said user using said presentation device.

38. The method as recited in claim 37 wherein said one or more presentation attributes are visual presentation attributes.

39. The method as recited in claim 38 wherein said adapting said data includes adjusting said data to said visual presentation attributes to provide said non-degraded presentation experience.

40. The method as recited in claim 37 wherein said one or more presentation attributes are acoustical presentation attributes.

41. The method as recited in claim 40 wherein said adapting said data includes adjusting said data to said acoustical presentation attributes to provide said non-degraded presentation experience.

42. The method as recited in claim 37 wherein said adapting said data includes adjusting said data to hearing attributes of said user to provide said non-degraded presentation experience.

43. The method as recited in claim 37 wherein each presentation attribute is one of a static presentation attribute and a dynamic presentation attribute.

44. A system for providing a user a non-degraded presentation experience from data using one of a plurality of presentation devices while limiting access to said non-degraded presentation experience, comprising:
a data storage unit for storing said data;
a presentation attribute unit for gathering one or more presentation attributes of anyone of said presentation devices, wherein each one of said presentation devices has distinct presentation attributes; and
an adaptation processing unit for adapting said data using said one or more presentation attributes so that said non-degraded presentation experience is available solely from a presentation device associated with said presentation attributes.

45. The system as recited in claim 44 wherein said one or more presentation attributes are visual presentation attributes.

46. The system as recited in claim 45 wherein said adaptation processing unit adjusts said data to said visual presentation attributes to provide said non-degraded presentation experience.

47. The system as recited in claim 44 wherein said one or more presentation attributes are acoustical presentation attributes.

48. The system as recited in claim 47 wherein said adaptation processing unit adjusts said data to said acoustical presentation attributes to provide said non-degraded presentation experience.

49. The system as recited in claim 44 wherein said adaptation processing unit adjusts said data to hearing attributes of said user to provide said non-degraded presentation experience.

50. The system as recited in claim 44 wherein each presentation attribute is one of a static presentation attribute and a dynamic presentation attribute.

51. A method of providing a non-degraded presentation experience from data while limiting access to said non-degraded presentation experience, said method comprising:
accessing one or more user attributes associated with a user and one or more environmental attributes associated with an environment of said user;
accessing said data; and
adapting said data using said one or more user attributes and said one or more environmental attributes to generate adapted data that is presented to said user.

52. The method as recited in claim 51 wherein a user attribute is selected from the group consisting of: eye movement; head movement; and virtual movement in a virtual environment.

53. The method as recited in claim 52 wherein said adapting said data includes:
in a foveal field of a visual field of said user as indicated by said eye movement, maintaining said data in a state supporting said non-degraded presentation experience; and
outside of said foveal field, maintaining said data in a state supporting a degraded presentation experience.

54. The method as recited in claim 52 wherein said adapting said data includes:
in a hearing position of said user as indicated by said head movement, maintaining said data in a state supporting said non-degraded presentation experience; and
outside of said hearing position, maintaining said data in a state supporting a degraded presentation experience.

55. The method as recited in claim 52 wherein said adapting said data includes:
in a position of said user as indicated by said virtual movement, maintaining said data in a state supporting said non-degraded presentation experience; and
outside of said position, maintaining said data in a state supporting a degraded presentation experience.

56. The method as recited in claim 51 wherein an environmental attribute is selected from the group consisting of: acoustical attributes of said environment; and optical attributes of said environment.

57. The method as recited in claim 56 wherein said adapting said data includes adjusting said data to said acoustical attributes to provide said non-degraded presentation experience.

58. The method as recited in claim 56 wherein said adapting said data includes adjusting said data to said optical attributes to provide said non-degraded presentation experience.

59. The method as recited in claim 51 wherein each of said user attributes and each of said environmental attributes is one of a static attribute and a dynamic attribute.

60. A system for providing a non-degraded presentation experience from data while limiting access to said non-degraded presentation experience, said system comprising:
a data storage unit for storing said data;
an attribute unit for providing one or more user attributes associated with a user and one or more environmental attributes associated with an environment of said user; and
an adaptation processing unit for adapting said data using said one or more user attributes and said one or more environmental attributes to generate adapted data that is presented to said user.

61. The system as recited in claim 60 wherein a user attribute is selected from the group consisting of: eye movement; head movement; and virtual movement in a virtual environment.

62. The system as recited in claim 61 wherein said adaptation processing unit, in a foveal field of a visual field of said user as indicated by said eye movement, maintains said data in a state supporting said non-degraded presentation experience, and wherein said adaptation processing unit, outside of said foveal field, maintains said data in a state supporting a degraded presentation experience.

63. The system as recited in claim 61 wherein said adaptation processing unit, in a hearing position of said user as indicated by said head movement, maintains said data in a state supporting said non-degraded presentation experience, and wherein said adaptation processing unit, outside of said hearing position, maintains said data in a state supporting a degraded presentation experience.

64. The system as recited in claim 61 wherein said adaptation processing unit, in a position of said user as indicated by said virtual movement, maintains said data in a state supporting said non-degraded presentation experience, and wherein said adaptation processing unit, outside of said position, maintains said data in a state supporting a degraded presentation experience.

65. The system as recited in claim 60 wherein an environmental attribute is selected from the group consisting of: acoustical attributes of said environment; and optical attributes of said environment.

66. The system as recited in claim 65 wherein said adaptation processing unit adjusts said data to said acoustical attributes to provide said non-degraded presentation experience.

67. The system as recited in claim 65 wherein said adaptation processing unit adjusts said data to said optical attributes to provide said non-degraded presentation experience.

68. The system as recited in claim 60 wherein each of said user attributes and each of said environmental attributes is one of a static attribute and a dynamic attribute.
